(19) United States
(12) Patent Application Publication
(10) Pub. No.: US 2010/0186837 A1
(43) Pub. Date: Jul. 29, 2010

(54) Tap For Pressurized Gas Cylinder

(76) Inventors: Christian Bleys, Cerans-Foulletourte (FR); Pedro Collado, Ozoir La Ferriere (FR); Fabrice Pin, Viroflay (FR); Philippe Deck, Montreuil (FR)

Correspondence Address: AIR LIQUIDE USA LLC;Intellectual Property, 2700 POST OAK BOULEVARD, SUITE 1800, HOUSTON, TX, 77056, US

(21) Appl. No.: 12/593,318

(22) PCT Filed: Feb. 14, 2008
(86) PCT No.: PCT/FR08/50243

§ 371 Date: Apr. 7, 2010

(30) Foreign Application Priority Data
Mar. 29, 2007 (FR) 0754116

(51) Int. Cl. F16K 1/52; F16K 31/44; F16K 27/12

(52) U.S. Cl. 137/614.11; 137/382

(57) ABSTRACT

The invention relates to a tap (1) for a pressurized gas cylinder, that comprises a body (2) to be connected to a gas (G) outlet opening (3) of a gas cylinder (4), un gas (G) off-take circuit (C) including at least one gas outlet (5, 25), at least one valve (6) movable between a circuit (C) closing position and a circuit (C) opening position, at least one member (23) for adjusting the release flow of the gas (G), and a single actuation member (9) capable of interaction both with the valve (6) and with the flow adjustment member (23), characterized in that the actuation member (9) is mounted so as to be movable relative to the body (2) according to two distinct movements, said actuation member (9) being arranged relative to the valve (6) and the flow adjustment member (7) so that the two types of movements respectively control the movement of the valve (6) between the opening and closing positions on the one hand and the flow adjustment member (23) on the other hand. The invention can be used as a tap with a built-in expander for a pressurized gas cylinder, e.g. pressurized oxygen in particular for oxygen therapy in medicine.

The present invention relates to a tap for a pressurized gas cylinder.

The invention relates more specifically to a tap for a pressurized gas cylinder comprising a body intended to be connected to an outlet orifice collecting gas out of a gas cylinder, a withdrawing circuit for withdrawing the gas comprising at least one gas outlet, at least one valve shutter able to move between a position in which it closes the circuit and a position in which it opens the circuit, at least one regulating element for regulating the flow rate at which the gas is released, and a single actuating member able to collaborate both with the valve shutter and with the flow regulating element.

Taps for pressurized gas cylinders are known from the prior art. Such devices, as a general rule, comprise a tap to operate to let high pressure gas out and a tap to operate to regulate the flow rate of the gas, generally expanded to a lower pressure, toward the outlet. This presents a disadvantage particularly when being used in the context of medical emergencies. This is because in such instances, the user of an oxygen cylinder equipped with two separate taps, one for letting the gas out at high pressure and another to regulate the rate at which the expanded gas is let out to the patient, has to perform two successive movements, a first movement to open the first tap and a second movement to open the second tap. The same difficulty also arises when closing the taps. This takes time to the detriment of the patient. In addition, there are therefore frequent handling errors because the user can easily make a mistake as to which tap is which or as to the order in which to open the two taps.

Document EP 1 327 804 discloses a tap device for a pressurized gas cylinder that is aimed at solving this problem. This device comprises a handwheel the turning of which operates, in two successive stages, the means that close the valve of the tap or that open the valve of the tap to release the gas and the means that regulate the flow rate at which the released gas is let out.

That device does not satisfactorily address the disadvantages mentioned hereinabove. In particular, that arrangement is a source of misunderstanding between the operating states which are, on the one hand, the opening of the valve and, on the other hand, the regulating of the gas flow rate. The user saves very little time over the other already-known devices and may very often make a mistake over the direction in which the handwheel should be turned, causing the valve to be closed instead of opened, and vice versa, something which may have dramatic consequences for the patient. This device cannot therefore be operated in complete safety, during emergency operations for example.

It is an object of the present invention to alleviate all or some of the abovementioned disadvantages of the prior art.

To this end, a tap according to the invention, in other respects in accordance with the generic definition given thereof in the above preamble, is essentially characterized in that the actuating member is mounted such that it can move relative to the body in two different types of movement, said actuating member being arranged relative to the valve shutter and to the flow regulating element in such a way that the two types of movement respectively on the one hand cause the valve shutter to move between its open and closed position and, on the other hand, operate the flow regulating element.

Furthermore, some embodiments of the invention may include one or more of the following features:
the actuating member is mounted so that it can move relative to the body in a translational first movement in which it causes the valve shutter to move between its open and closed positions, and a rotational second movement in which it operates the flow regulating element,
the tap comprises a removable locking member that locks the actuating member in a position in which the valve shutter is open,
the tap comprises at least one return element which by default urges the valve shutter toward its closed position,
the circuit comprises a high pressure inlet intended to be connected with the inside of a pressurized gas cylinder and a high pressure regulator situated between the valve shutter and the high pressure inlet,
the tap comprises a low pressure regulator situated downstream of the valve shutter, that is to say between the valve shutter and at least one outlet of the circuit,
the tap comprises at least one first outlet with a regulated delivery of gas, situated downstream of the flow regulating element, and a second outlet known as a pressure outlet, situated upstream of the flow regulating element and downstream of the low pressure regulator,
the second outlet comprises an access valve shutter for controlling the opening and closing thereof,
the flow regulating element moves as one with the actuating member in at least one of its two types of movement relative to the body,
the flow regulating element is arranged between the valve shutter and at least one outlet, the flow regulating element comprising a plurality of orifices of different diameters each corresponding to a respective predefined delivery,
the actuating member collaborates with the valve shutter by direct contact or indirect contact as it moves in one of its two types of movement relative to the body,
the tap comprises at least one guide means such as a stop system collaborating with the actuating member to prevent the latter from moving in a second type of movement (for example rotation) when the first type of movement (for example translation) has not yet been performed beforehand,
the tap comprises some form of safety relief valve situated upstream of the valve shutter and designed to release the gas in the event of overpressure or abnormal temperature,
the valve shutter that opens/closes the circuit is mounted such that it can slide in the body,
the tap comprises a system of notches collaborating with the actuating member to form stable positions or hard points in the movements corresponding to the operations of regulating the flow,
the gas circuit C comprises a filter situated in a gas pipe downstream of the gas inlet, downstream of the filter the circuit comprises several pipes, it being possible for a first tap to be connected to a pressure gage, a second being connected to a filling orifice and a third pipe forming a gas release duct, opened or closed by the valve shutter, for releasing gas to at least one outlet of the tap,
the high pressure regulator is situated between the filter and the valve shutter,
the high pressure regulator is designed to drop the pressure of the gas from a first pressure to a second pressure, the first pressure ranging from, for example, between 200 and 300 bar and the second pressure ranging, for example, between 10 and 15 bar.

Other specifics and advantages will become apparent from reading the description that follows, given with reference to the figures in which:

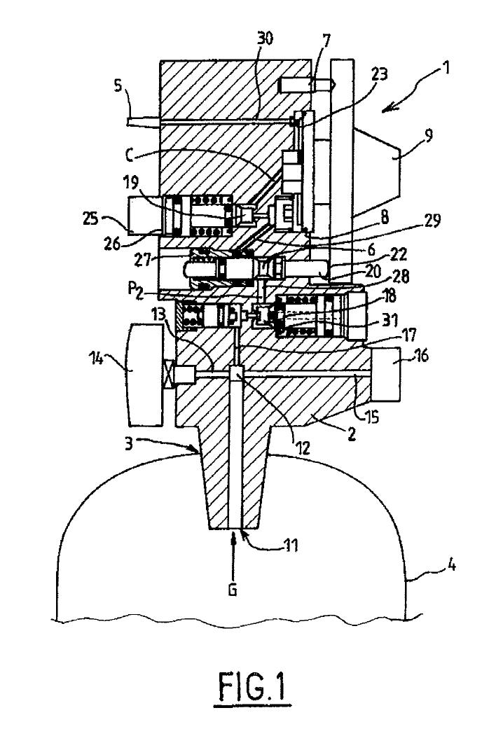

FIG. 1 schematically depicts a sectional view of one exemplary embodiment of a tap according to the invention with its valve shutter in the closed position,

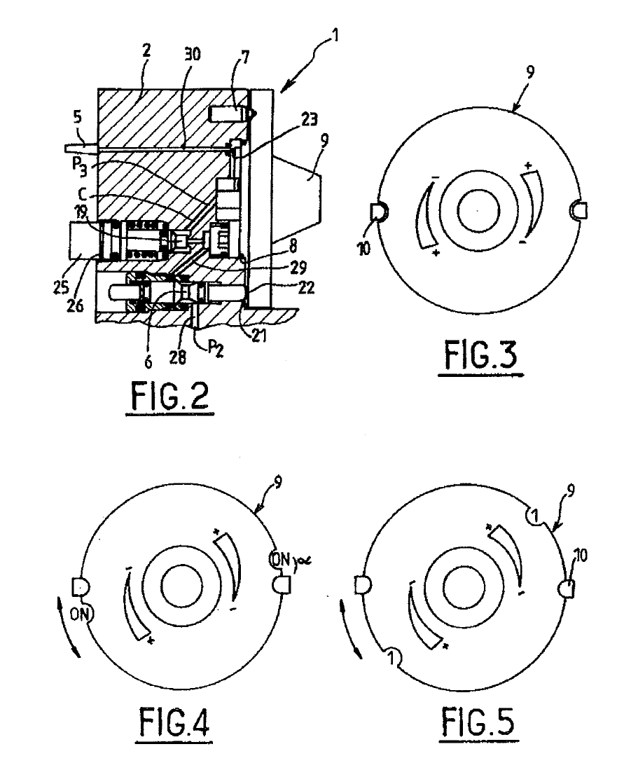

FIG. 2 schematically depicts a sectional view of a detail of the tap of FIG. 1, with its valve shutter in the open position,

FIG. 3 is a front view of the actuating member of the tap of FIG. 1, with the valve shutter of a tap according to the invention in the closed position,

FIG. 4 is a front view of the same actuating member with the valve shutter of the tap in the open position and without the outlet delivery regulated,

FIG. 5 is a front view of the same actuating member in a position in which the valve shutter of the tap is in the open position and an outlet delivery has been set,

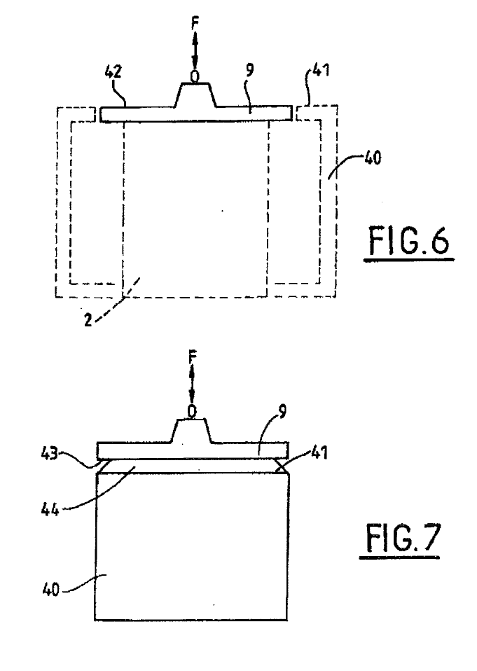

FIGS. 6 and 7 schematically depict two exemplary applications of a tap according to the invention, in which the actuating member collaborates with a protective case or protective bonnet of the tap.

The tap 1 depicted in FIG. 1 comprises a body 2 connected to an outlet orifice 3 for letting gas G out of a gas cylinder 4.

A withdrawing circuit C for withdrawing gas G is formed in the body 2 to connect a gas inlet 11 for the gas G, which is connected to the inside of the cylinder 4, to at least one gas release outlet 5, 25. As depicted in FIG. 1, a filter 12 may be provided downstream of the inlet 11. Downstream of the filter 12, the circuit C splits into several pipes. A first pipe 13 communicates with a pressure gage 14 mounted on the body 2. A second pipe 15 is connected to a filling connector 16. A third pipe 17 or relief duct conveys gas toward one or more outlets 5, 25. Downstream of the filter 12, the relief pipe 17 of the circuit C comprises a safety relief valve 31 intended to prevent the elements downstream from being subjected to a high pressure if an accidental leak arises. As a result, the above mechanical design becomes simple to embody and makes it possible to imagine maintenance-free life spans equivalent to that of a simple tap, for example longer than ten years.

Downstream of the safety relief valve 31, the circuit C comprises a first regulator 18, known as the “high pressure regulator”, designed to expand the gas from the high pressure P1 of the cylinder 4, for example ranging between 200 bar and 300 bar or more, to a lower intermediate pressure P2, for example ranging between 10 bar and about 15 bar.

Downstream of the high pressure regulator 18, circuit C comprises an opening/closing valve shutter 6 intended to allow or prevent the release of gas to an outlet 5, of the tap 1. By virtue of the presence of this high pressure regulator 18, all the elements situated down-stream of the valve shutter 6, including the moving parts and the seals present in the circuit C for correct operation of the tap are, according to the invention, subjected to a relatively low pressure, of P2 or less. These elements are therefore subjected to low stresses both in terms of pressure and in terms of friction and are therefore not subjected to the significant amounts of wear such as are found in taps of the prior art.

The valve shutter 6 is able to move, for example, in translation, between a position 20 in which it closes the circuit C and a position 21 in which the circuit C is open. In the example of FIG. 1, the circuit C is closed, the closed position of the valve shutter 6 prevents gas from flowing in the circuit C between the upstream portion 28 and the downstream portion 29 of the valve shutter 6.

The tap 1 may also comprise a low pressure regulator 19 situated downstream of the valve shutter 6, that is to say between the valve shutter 6 and at least one outlet 5, 25 of the circuit C. This low pressure regulator allows gas to flow downstream at a constant pressure P3, the pressure P3 ranging, for example, between 1 and 5 bar. Thus, the elements situated downstream of the low pressure regulator 19 are no longer subjected to pressure fluctuations. The constant low pressure obtained makes it possible to obtain stable flow rates at the outlets 5 and 25 from the tap, making such a tap far easier to use and improving its safety and the safety of the patients or users.

The tap 1 comprises at least one regulating element 23 for regulating the rate of flow at which the gas G admitted to an outlet 5 is released, and a single actuating member 9 able both to operate the valve shutter 6 and to operate the flow regulating element 23.

The actuating member 9 comprises, for example, a handwheel, mounted such that it can move relative to the body 2 and able in translational movements to cause the valve shutter 6 to move between its open 21 and closed 20 positions.

In FIG. 2, the user has imposed a translational movement, toward the body 2, on the actuating member 9.

The actuating member 9 is able to move the valve shutter 6 toward an open position 21, by contact between an end 22 of the valve shutter 6 and the actuating member 9. The open position 21 of the valve shutter 6 allows gas in the circuit C to be released toward an outlet 5, 25.

As a preference, the valve shutter 6 is mounted such that it can slide and is urged by at least one return element 27 toward its closed position 20. One end 22 of the valve shutter 6 is kept in contact with the actuating member 9 by the return element 27. Thus, the return element 27 applies a force to the actuating member 9 to push it translationally toward the outside of the body 2 so as to leave the valve shutter 6 in the closed position 20 and thus ensure that the default state of the circuit C is the state in which the circuit is closed off. This default closing off is performed when the user has not imposed any translational movement, toward the body 2, on the actuating member 9.

Once the circuit C is open, the actuating member 9 is also able, as it turns, to operate the regulating element 23 that regulates the rate of outlet flow of the gas G.

According to one particular embodiment of the invention, the tap 1 comprises at least one first outlet 5 known as the delivery outlet, situated downstream of the flow regulating element 23. The tap 1 comprises at least one second outlet 25 known as the pressure outlet situated upstream of the flow regulating element 23 and downstream of the low pressure regulator 19. The second outlet 25 may comprise a valve shutter 26 for opening it and closing it and able to collaborate, for example, with a coupling of a chosen apparatus. Thus, the user is free to arrange this second outlet 25 such that it releases gas G at low pressure to a device of his choosing. This then is a certain advantage of the tap according to the invention because in order to use this second outlet 25 the user has merely to open the circuit C, operating the actuating member 9 in a simple translational movement thereof toward the body 2, followed by a turning through just a few degrees. Further, the user can operate the two outlets 5 and 25 simultaneously by continuing to turn the actuating member 9, the delivery outlet 5 allowing a release of gas at a chosen flow rate.

The regulating element 23 comprises a portion 8, for example a disk, that rotates as one with the actuating member 9, arranged between the valve shutter 6 and at least one so-called delivery outlet 5. The disk comprises a plurality of orifices of different diameters each corresponding to a predefined delivery.

Turning the actuating member 9 makes it possible, through collaboration between the portion 8 and the regulating element 23, to set one of the orifices facing one end 30 of the circuit C that releases gas G. The delivery is set by the diameter of orifice chosen.

The above mechanism presents a considerable advantage over the prior art because in order to open the circuit C and thus allow the gas G to circulate freely as required for withdrawing it, the user has to apply only a very small amount of effort that is very easy to do: all he has to do is press the actuating member 9 to give rise to a translational movement causing the valve shutter 6 to move into the open position 21. Next, a determined amount of turning locks the valve shutter 6 in the open position.

In addition, if the user wishes a precise outlet flow of gas G, for example for a mask, this precise delivery is available at the so-called pressure outlet 25.

Next, the user can set the gas outlet delivery he desires, available at the so-called delivery outlet 5, simply by turning the actuating member 9 some more. Thus, the risk of errors as to the opening or closing of the circuit C is very low. In addition, the user can be assured that the circuit C is open when he is regulating the delivery and likewise he can be assured that the circuit C is closed when the valve shutter 6 is in the closed position 20.

In FIG. 3, the actuating member 9 is in the rest position, a locking member 10, such as stop system, prevents said actuating member 9 from turning so the only movement that the user can perform is a translational movement of the actuating member 9 toward the body 2.

In FIG. 4, the circuit C is open because the valve shutter 6 has been driven into its open position 21 by the translational movement of the actuating member 9 in contact with the end 22 of the valve shutter 6. The turning of the actuating member 9 is therefore unblocked, which has made it possible, in FIG. 4, for the user to turn the actuating member 9 through a determined first angle α allowing him, for example, to use the so-called pressure outlet 25 without having to regulate the outlet flow rate of the gas G. In addition, the rotation through a first angle α prevents the valve shutter 6 from returning to a closed position because the translational movement of the valve shutter 6 is blocked by the locking member 10, for example a stop.

In FIG. 5, the user has chosen a delivery and has therefore imposed an additional rotational movement on the actuating member 9 so that one of the flow regulating orifices comes to face one end 30 of the gas G release circuit C. The delivery is set by the diameter of orifice chosen, the actuating member 9 is still blocked in terms of translational movement in the position in which the valve shutter 6 is open. The positions of the selected deliveries are preferably marked by hard or stable points, for example a ball and spring means 7 contained either in the body 2 or in the regulating element 23 and collaborating with housings in the actuating member 9.

In order to choose a new delivery, the user unblocks the actuating member 9 by applying to it enough force to make it turn and to choose to position another orifice of a different diameter facing an end 30 of the gas G release circuit C. Alphanumeric references are preferably provided on the body 2 and/or the actuating member 9 to indicate the chosen delivery (0: open no delivery, 1: first delivery, 2: second delivery, etc).

FIG. 6 schematically depicts a tap 1 according to the invention as a rectangle drawn in dotted line in a position protected by a bonnet or protective cover 40 itself depicted schematically in dotted line. The tap depicted in FIG. 6 differs from the one described hereinabove in that the actuating member 9 is situated at the upper part of the body 2 of the tap. When the tap 1 is in the closed position F, the actuating member projects above the end 41 of the bonnet or protective cover 40. When the user imposes a translational movement toward the body 2 on the actuating member 9 in order to place the tap 1 in the open position O, the end 42 of the actuating member 9 is at least in part substantially in the same plane as the upper end 41 of the protective bonnet 40. Alphanumeric references may be present on the bonnet or the protective cover 40 and on the actuating member 9, to indicate the various positions of the tap (open, closed, chosen delivery).

In FIG. 7, the tap 1 according to FIG. 6 is protected by another bonnet or protective cover 40.

When the tap 1 is in the closed position F, the actuating member 9 is in a position of maximum separation from the top end 41 of the protective bonnet 40. When the user is not imposing a translational movement toward the body 2 on the actuating member 9 so as to place the tap 1 in the open position O, the end of the actuating member 9 is very close to, for example practically in contact with, the end 41 of the protective bonnet 40. This embodiment of the invention also affords the advantage of making it possible to introduce, in addition to the alphanumeric references already mentioned hereinabove, a color code providing a better visual indication of the open/closed positions of the tap. For example, the zone of connection 44 between the actuating member 9 and the bonnet or protective cover 40 predominantly appears in a certain color when the tap 1 is in the closed position F and in a different color when the tap 1 is in the open position O. The color of the alphanumeric references corresponding to the various positions of the tap 1, namely open O, closed F, and the chosen delivery, may also vary in the same way.

The proposed solution therefore defines ergonomics that give a better and unambiguous view of the open position of the tap 1 in a way that is clear and visible from afar.

This last aspect makes it possible to avoid the risks of unintentional operatings of the tap 1 because if there actually is a change in position of the tap 1, the user will be visually well informed of this.

It should be obvious that the present invention allows embodiments in numerous other specific forms without departing from the field of application of the invention as claimed. As a result, the present embodiments are to be considered by way of illustration, but may be modified within the domain defined by the scope of the attached claims, and the invention should not be restricted to the details given hereinabove.

1-12. (canceled)

13. A tap for a pressurized gas cylinder comprising a body intended to be connected to an outlet orifice collecting gas (G) out of a gas cylinder, a withdrawing circuit (C) for withdrawing the gas (G) comprising at least one gas outlet, at least one valve shutter able to move between a position in which it closes the circuit (C) and a position in which it opens the circuit (C), at least one regulating element for regulating the flow rate at which the gas is released, and a single actuating member able to collaborate both with the valve shutter and with the flow regulating element, the actuating member mounted such that it can move relative to the body in two different types of movement, and the actuating member arranged relative to the valve shutter and to the flow regulating element in such a way that the two types of movement respectively on the one hand cause the valve shutter to move between its open and closed position and, on the other hand, operate the flow regulating element.

14. The tap of claim 13, wherein the actuating member is mounted so that it can move relative to the body in a translational first movement in which it causes the valve shutter to move between its open and closed positions, and a rotational second movement in which it operates the flow regulating element.

15. The tap of claim 13, wherein the tap comprises a removable locking member that locks the actuating member in a position in which the valve shutter is open.

16. The tap of claim 13, wherein the tap comprises at least one return element which by default urges the valve shutter toward its closed position.

17. The tap of claim 13, wherein the circuit (C) comprises a high pressure inlet intended to be connected with the inside of a pressurized gas cylinder and a high pressure regulator situated between the valve shutter and the high pressure inlet.

18. The tap of claim 13, wherein the tap comprises a low pressure regulator situated downstream of the valve shutter, that is to say between the valve shutter and at least one outlet of the circuit.

19. The tap of claim 18, wherein the tap comprises at least one first outlet with a regulated delivery of gas, situated downstream of the flow regulating element, and a second outlet known as a pressure outlet, situated upstream of the flow regulating element and downstream of the low pressure regulator.

20. The tap of claim 19, wherein the second outlet comprises an access valve shutter for controlling the opening and closing thereof.

21. The tap of claim 13, wherein the flow regulating element moves as one with the actuating member in at least one of its two types of movement relative to the body.

22. The tap of claim 21, wherein the flow regulating element is arranged between the valve shutter and at least one outlet, the flow regulating element comprising a plurality of orifices of different diameters each corresponding to a respective predefined delivery.

23. The tap of claim 13, wherein the actuating member collaborates with the valve shutter by direct contact or indirect contact as it moves in one of its two types of movement relative to the body.

24. A tap for a pressurized gas cylinder comprising:
a body intended to be connected to an outlet orifice collecting gas (G) out of a gas cylinder,
a withdrawing circuit (C) for withdrawing the gas (G) comprising at least one gas outlet, at least one valve shutter able to move between a position in which it closes the circuit (C) and a position in which it opens the circuit (C), a high pressure inlet intended to be connected with the inside of the pressurized gas cylinder and a high pressure regulator situated between the valve shutter and the high pressure inlet,
at least one regulating element for regulating the flow rate at which the gas is released,
a single actuating member able to collaborate both with the valve shutter and with the flow regulating element, the actuating member mounted such that it can move relative to the body in two different types of movement, and the actuating member arranged relative to the valve shutter and to the flow regulating element in such a way that the two types of movement respectively on the one hand cause the valve shutter to move between its open and closed position and, on the other hand, operate the flow regulating element,
a removable locking member that locks the actuating member in a position in which the valve shutter is open,
at least one return element which by default urges the valve shutter toward its closed position, and
a low pressure regulator situated downstream of the valve shutter, between the valve shutter and the at least one outlet of the circuit (C).

25. An assembly of a tap and bonnet or protective cover for a pressurized gas cylinder, wherein the tap comprises a body intended to be connected to an outlet orifice collecting gas (G) out of a gas cylinder, a withdrawing circuit (C) for withdrawing the gas (G) comprising at least one gas outlet, at least one valve shutter able to move between a position in which it closes the circuit (C) and a position in which it opens the circuit (C), at least one regulating element for regulating the flow rate at which the gas is released, and a single actuating member able to collaborate both with the valve shutter and with the flow regulating element, the actuating member mounted such that it can move relative to the body in two different types of movement, and said actuating member being arranged relative to the valve shutter and to the flow regulating element in such a way that the two types of movement respectively on the one hand cause the valve shutter to move between its open and closed position and, on the other hand, operate the flow regulating element, the tap protected by said bonnet or protective cover, the actuating member moving, in the first type of movement, between a position of maximum separation from the bonnet or protective cover, when the tap is in the closed position (F), and a position of minimum separation from the bonnet or protective cover when the tap is in the open position (O).
